(19) United States
(12) Patent Application Publication
(10) Pub. No.: US 2007/0103550 A1
(43) Pub. Date: May 10, 2007

(54) Method and system for detecting relative motion using one or more motion sensors

(76) Inventors: Michael L. Frank, Menlo Park, CA (US); David W. Dolfi, Los Altos, CA (US); Steven A. Rosenau, Mountain View, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/270,345

(22) Filed: Nov. 9, 2005

(51) Int. Cl. H04N 7/18

(52) U.S. Cl. 348/154

(57) ABSTRACT

One or more optical motion sensors are connected to a central processing device. At least one of the motion sensors captures representations of a region, such as images or patterns that represent the region. Each optical motion sensor processes its representations to generate resulting data that are used to detect whether an object moved in relation to a respective motion sensor. Any relative motion may be detected by each optical motion sensor or by the central processing device using resulting data received from the optical motion sensor or sensors.

### BACKGROUND

Motion detection systems are used in a variety of applications, such as security and energy conservation. One type of motion sensor detects motion when an object, such as a person or animal, breaks a beam of light by walking past the motion sensor. This type of motion sensor detects motion passively by requiring the object move in front of the sensor. Thus, the sensor can be accidentally or intentionally bypassed simply by not walking or moving in front of the sensor. Moreover, the motion sensor produces limited information because the sensor can only report the object is in a specific location.

Another type of motion sensor is a heat sensitive sensor. This type of sensor detects the presence of a person by detecting the heat generated by the human body. But electrical devices, such as computers, also generate heat. The motion sensor can therefore falsely detect the presence of a person when it detects the heat generated by electrical devices.

### SUMMARY

In accordance with the invention, a method and system for detecting relative motion using one or more motion sensors are provided. One or more optical motion sensors are connected to a central processing device. At least one of the motion sensors captures representations of a region, such as images or patterns that represent the region. Each optical motion sensor processes its representations to generate resulting data that are used to detect whether an object moved in relation to a respective motion sensor. Any relative motion may be detected by each optical motion sensor or by the central processing device using resulting data received from the optical motion sensor or sensors.

### BRIEF DESCRIPTION OF THE DRAWINGS

FIG. 1 is a block diagram of a motion sensor network in an embodiment in accordance with the invention;

FIG. 2 is a flowchart of a method for detecting relative motion in an embodiment in accordance with the invention;

FIG. 3 is a block diagram of a first motion sensor in an embodiment in accordance with the invention;

FIG. 4 is a block diagram of a second motion sensor in an embodiment in accordance with the invention;

FIG. 5 is a block diagram of a third motion sensor in an embodiment in accordance with the invention;

FIG. 6 is a graphic illustration of a motion sensor network employed in a hallway in an embodiment in accordance with the invention; and

FIG. 7 is a graphic illustration of a motion sensor network employed in a conference room in an embodiment in accordance with the invention.

### DETAILED DESCRIPTION

The following description is presented to enable embodiments of the invention to be made and used, and is provided in the context of a patent application and its requirements. Various modifications to the disclosed embodiments will be readily apparent, and the generic principles herein may be applied to other embodiments. Thus, the invention is not intended to be limited to the embodiments shown but is to be accorded the widest scope consistent with the appended claims. Like reference numerals designate corresponding parts throughout the figures.

Embodiments in accordance with the invention use one or more optical motion sensors to capture images or patterns and process the images or patterns to generate resulting data. Relative motion is detected by each motion sensor using its resulting data and a particular motion detection technique in an embodiment in accordance with the invention. In another embodiment in accordance with the invention, the one or more optical motion sensors transmit the resulting data to a central processing device that detects relative motion using the resulting data and a particular motion detection technique. Motion detection techniques include, but are not limited to, speckle translation, image correlation, and pattern analysis using light and shadow imaging or laser interferometry.

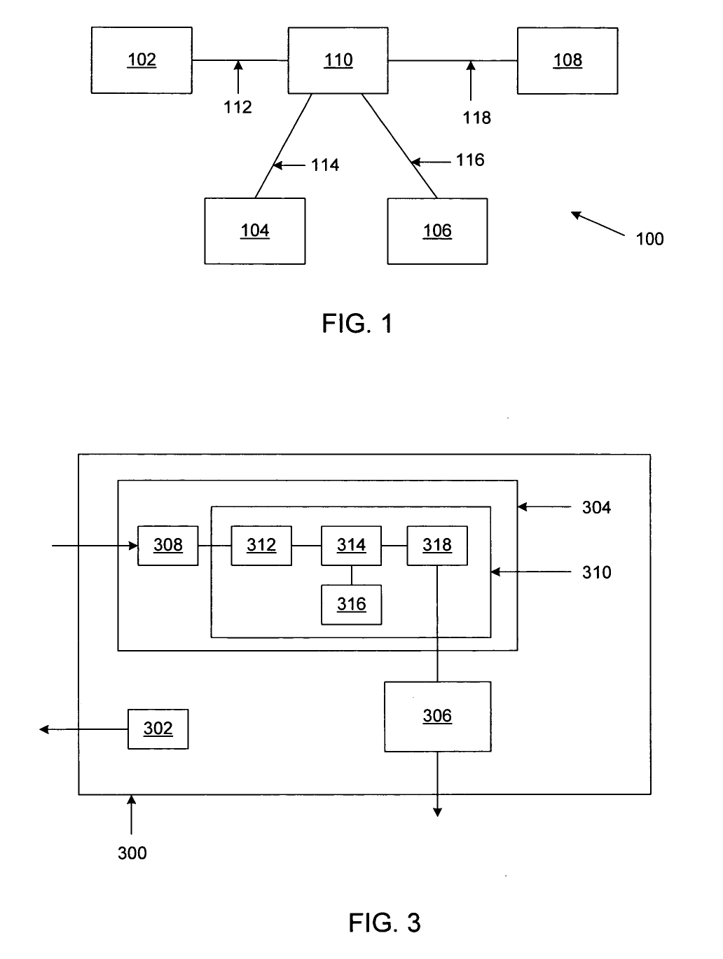

FIG. 1 is a block diagram of a motion sensor network in an embodiment in accordance with the invention. Motion sensor network 100 includes optical motion sensors 102, 104, 106, 108 connected to central processing device 110 through connections 112, 114, 116, 118, respectively. Connections 112, 114, 116, 118 are implemented as wireless connections in an embodiment in accordance with the invention.

Motion sensors 102, 104, 106, 108 are positioned in different locations and form a distributed network of optical motion sensors. Motion sensors 102, 104, 106, 108 are positioned in a self-contained region in an embodiment in accordance with the invention. Examples of a self-contained region include a room or hallway. In another embodiment in accordance with the invention, motion sensors are positioned in separate regions, such as, for example, throughout a building or a floor in the building.

Motion sensors 102, 104, 106, 108 are fixed in their locations and capture representations of one or more regions in an embodiment in accordance with the invention. For example, optical motion sensors 102,104, 106,108 may be placed in a conference room and each sensor captures representations of one or more regions or sections of the room. Each motion sensor processes its representations to generate resulting data. The resulting data are used to determine whether one or more objects moved with respect to the fixed location of each motion sensor. Relative motion may be determined by each optical motion sensor itself or by central processing device 110 using the resulting data received from motion sensors 102, 104, 106, 108 over the wireless connection.

Central processing device 110 is implemented as a computer in an embodiment in accordance with the invention. Central processing device 110 is positioned in the same location as one or more of the motion sensors 102, 104, 106, 108 in an embodiment in accordance with the invention. In another embodiment in accordance with the invention, central processing device 110 is positioned in a different location from motion sensors 102, 104, 106, 108.

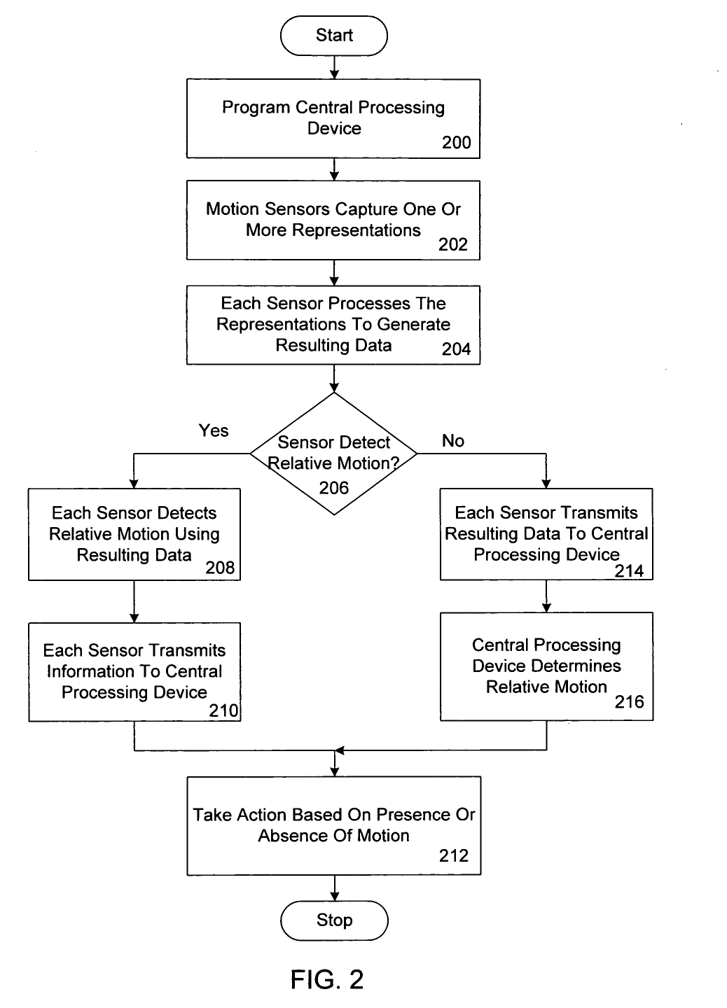

Referring to FIG. 2, there is shown a flowchart of a method for detecting motion in an embodiment in accordance with the invention. Initially the central processing device is programmed with one or more motion detection programs or parameters, as shown in block 200. The motion detection programs are used to detect relative motion using one or more motion detection techniques.

Motion detection parameters allow a motion detection program to be optimized or customized for a particular environment or application. For example, motion detection parameters can be used to define a region or zone that is to be excluded from the motion detection analysis. The zone may be excluded because any motion in that zone is not of interest. By way of another example, a motion detection program may include the ability to count the number of moving objects in the region or to determine the locations in the region where the motion occurred.

Next, at block 202, one or more motion sensors capture representations of one or more regions. The representations are images or patterns in an embodiment in accordance with the invention. Each sensor processes its representations to generate resulting data at block 204. The representations may be processed using a variety of techniques. For example, an image from one motion sensor may be correlated with another image in an embodiment in accordance with the invention. By way of another example, speckle or diffraction patterns may be analyzed to determine the presence or absence of motion.

A determination is then made at block 206 as to whether each sensor is to detect relative motion. If so, the method passes to block 208 where each optical motion sensor detects relative motion using the resulting data it generated. In other embodiments in accordance with the invention, one motion sensor may communicate with another motion sensor prior to detecting relative motion.

The optical motion sensors then transmit information to the central processing device regarding the presence or absence of relative motion (block 210). For example, only the motion sensors that detect relative motion may transmit a detect message to the central processing device in an embodiment in accordance with the invention. The central processing device initiates an action at block 212 based on the presence or absence of any relative motion. When motion is not detected, for example, the central processing device reduces or turns off the air conditioning in a room to save energy in an embodiment in accordance with the invention. As another example, if motion is detected, the lights in a room are turned on or maintained on in an embodiment in accordance with the invention.

Another action that may be initiated by the central processing device is additional processing of the resulting data in another embodiment in accordance with the invention. For example, the central processing device may determine the number of people in a room based on the locations where motion is detected and compare the number with a previously determined number in an embodiment in accordance with the invention. If the number of people in the room has increased, the level of air conditioning is increased in order to compensate for the increase in the number of people. When the comparison determines the number of people in the room has decreased, the level of air conditioning is decreased.

Returning to block 206, when the optical motion sensors are not to detect relative motion, the method passes to block 214 where each optical motion sensor transmits the resulting data to the central processing device. The central processing device then determines the presence or absence of any relative motion (block 216) and initiates an action based on the presence or absence of any relative motion (block 212).

FIG. 3 is a block diagram of a first motion sensor in an embodiment in accordance with the invention. Motion sensor 300 includes light source 302, motion detection system 304, and transmitter 306. Light source 302 is implemented as one or more light-emitting diodes in an embodiment in accordance with the invention. In another embodiment in accordance with the invention, light source 302 is implemented with one or more lasers, such as, for example, vertical cavity surface emitting lasers (VCSEL). And finally, in yet another embodiment in accordance with the invention, light source 302 is not used and motion sensor 300 uses ambient light to capture images or patterns.

Transmitter 306 is implemented with any type of wireless transmitter. Transmitter 306 is implemented as a low power wireless transmitter using a bulk acoustic wave (BAW) resonator in an embodiment in accordance with the invention. The film bulk acoustic resonator (FBAR) designed by Agilent Technologies, Inc. is one example of a BAW resonator.

Motion detection system 304 includes imager 308 and analyzing system 310. Imager 308 and analyzing system 310 are constructed in accordance with a given motion detection technique in an embodiment in accordance with the invention. Motion detection techniques include, but are not limited to, speckle translation, image correlation, and the use of diffraction patterns using coherent imaging or laser interferometry. Motion detection system 304 captures representations such as images or patterns, processes the representations, and transmits the resulting data to a central processing device for further processing in an embodiment in accordance with the invention. The motion may be detected by the motion sensor or by the central processing device using the resulting data.

For example, when motion sensor 300 uses speckle translation to detect relative motion, motion detection system 304 captures speckle patterns and detects changes in the speckle patterns. Imager 308 includes one or more spatial filters and analyzing system 310 includes phase quadrature decoder (PQD) 312, memory 314, controller 316, and measurement circuit 318. The implementation of analyzing system 310 is disclosed in commonly assigned U.S. patent application Ser. No. 11/016,651 filed on Dec. 17, 2004, which is incorporated herein by reference.

The Q and I channels output from the spatial filter or filters are input into PQD 312. PQD 312 generates a pulse every time a transition is made in either the forward (+) or backward (−) direction. It is assumed in one embodiment in accordance with the invention that the transitions move in a clockwise or counter-clockwise direction. Any transitions contrary to this assumption are then ignored. This assumption may be used to reduce spurious noise when determining velocity.

The pulses output from PQD 312 are transmitted to buffer 314. Controller 316 analyzes the pulses in buffer 314 to determination if there is a trend in the pulses. A trend occurs when a desired number of similarly signed pulses (“+” or “−”) are output from PQD 312. In an embodiment in accordance with the invention, the desired number of similarly signed pulses ranges from three to ten.

If controller 316 detects a trend in the pulses, one or more pulses are transmitted from buffer 314 to a central processing device (not shown) by transmitter 306. The central processing device can determine the velocity of the moving object by calculating the speed as inversely proportional to the average time between the successive or consistent output pulses of PQD 312. The direction of the motion is given by the sign of the pulses in an embodiment in accordance with the invention.

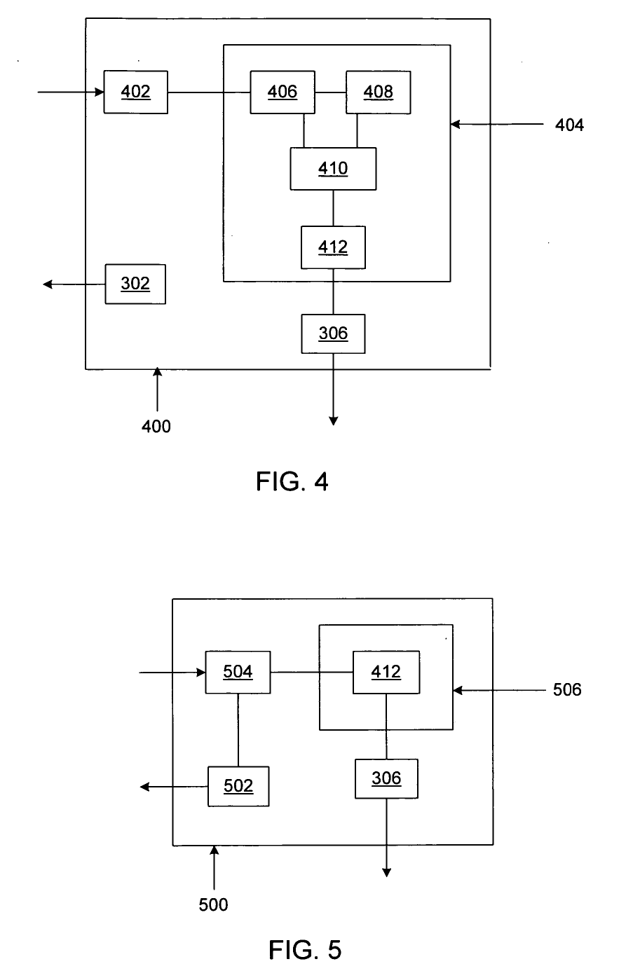

FIG. 4 is a block diagram of a second motion sensor in an embodiment in accordance with the invention. Motion sensor 400 includes light source 302, imager 402, analyzing system 404, and transmitter 306. Analyzing system 404 includes memory 406, difference image generator 408, correlator 410, and processing device 412. Motion sensor 400 detects relative motion using image correlation in an embodiment in accordance with the invention. Analyzing system 404 is disclosed in commonly assigned U.S. patent application Ser. No. 11/014,482 filed on Dec. 16, 2004, which is incorporated herein by reference.

Imager 402 captures an image I(n) and transmits the image to memory 406. Imager 402 then captures another image, image I(n+1). Image I(n+1) is also stored in memory 406. The images are then input into difference image generator 408 in order to generate a difference image. The difference image and one of the images used to create the difference image are correlated by correlator 410. Processing circuit 412 then performs a thresholding operation and generates a navigation vector when motion has occurred between the time image I(n) and image I(n+1) are captured.

A clock (not shown) is connected to imager 402 in an embodiment in accordance with the invention. The clock permits imager 402 to capture and transmit the images to memory 406 synchronously. This allows motion sensor 400 to determine an absolute magnitude reference in an embodiment in accordance with the invention. In other embodiments in accordance with the invention, the clock may not be included in motion sensor 400.

Embodiments in accordance with the invention are not limited to the implementation of analyzing system 404 shown in FIG. 4. Other motion detection techniques may use different components or only a portion of the components shown in FIG. 4. For example, motion sensor 400 may detect relative motion using patterns of light and shadows in an embodiment in accordance with the invention. Analyzing system 404 would therefore include memory 406 and correlator 410. Light source 302 emits light towards a region while imager 402 captures representations of the region using reflected light. The reflected light produces patterns of light and shadow that are stored in memory 406. Correlator 410 correlates the patterns to determine whether there are any changes in the patterns. The motion of an object is determined by the changes in the patterns.

Referring to FIG. 5, there is shown a block diagram of a third motion sensor in an embodiment in accordance with the invention. Motion sensor 500 includes laser 502, imager 504, and analyzing system 506. Analyzing system 506 includes correlator 412. Laser interferometry is the motion detection technique used in conjunction with motion sensor 500 in an embodiment in accordance with the invention.

Laser 502 emits light towards a region. A portion of the emitted light is also input to imager 504. Imager 504 captures representations of the regions using light reflected from the region. The representations are interference patterns created by the differences between the emitted light and the reflected light. Correlator 412 correlates the interference patterns to determine whether there are any changes in the patterns. The motion of an object is determined by the changes in the patterns.

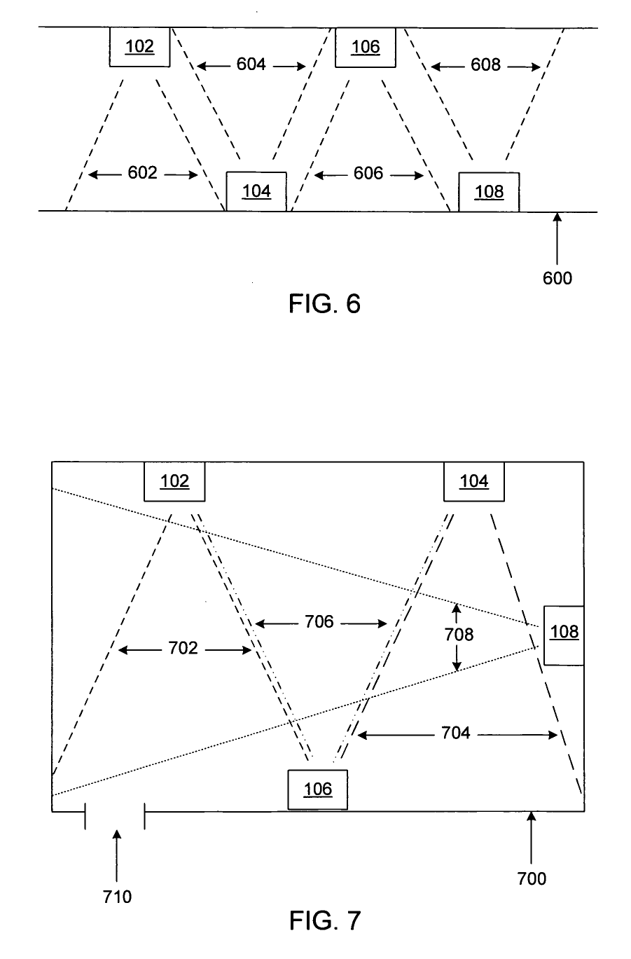

FIG. 6 is a graphic illustration of a motion sensor network employed in a hallway in an embodiment in accordance with the invention. Hallway 600 includes optical motion sensors 102, 104, 106, 108. The dashed lines illustrate a field of view 602, 604, 606, 608 for the imager in each motion sensor 102, 104, 106, 108, respectively. Motion sensors 102, 104, 106, 108 are used to detect any relative motion in hallway 600.

One or more of the motion sensors 102, 104, 106, 108 capture representations of its field of view 602, 604, 606, 608 and process the representations to determine whether a person or object moves with respect to at least one of the motion sensors. Processing of the representations generates resulting data that are transmitted to a central processing device (not shown). If motion is detected in hallway 600, one or more actions are taken, such as, for example, turning on lights, activating an alarm, or turning on a security video camera in order to view the object that caused the motion.

FIG. 7 is a graphic illustration a motion sensor network employed in a conference room in an embodiment in accordance with the invention. Conference room 700 includes motion sensors 102, 104, 106, 108. The dashed lines depict a field of view 702, 704, 706, 708 for the imager in each motion sensor 102, 104, 106, 108, respectively. Motion sensors 102, 104, 106, 108 are fixed in their locations in order to detect any relative motion in conference room 700.

One or more of the motion sensors 102, 104, 106, 108 capture representations of its field of view 702, 704, 706, 708 and process the representations to determine whether a person moves with respect to at least one of the motion sensors. Processing of the representations generates resulting data that are transmitted to a central processing device (not shown). If motion is detected in conference room 700 or entryway 710, one or more actions are taken, such as, for example, turning on lights and air conditioning for conference room 700.

1. A motion sensor for use in detecting relative motion in a region, the motion sensor comprising:
an imaging device having a field of view that includes at least a portion of the region, wherein the imaging device captures representations of the field of view;
an analyzing system coupled to the imaging device for processing the representations in order to detect relative motion in the field of view; and
a wireless transmitter coupled to the analyzing system for transmitting data associated with the processed representations.

2. The motion sensor of claim 1, further comprising a memory coupled to the imaging device.

3. The motion sensor of claim 1, further comprising a light source for emitting light towards the region.

4. The motion sensor of claim 1, wherein the wireless transmitter comprises a low power transmitter with a bulk acoustic wave resonator.

5. The motion sensor of claim 1, wherein the representations comprise one of images and patterns.

6. A motion detection network for detecting relative motion in one or more regions, comprising:
a central processing device; and
one or more motion sensors each coupled to the central processing device using a wireless connection, wherein at least one of the one or more motion sensors captures representations of a respective region for detecting relative motion.

7. The motion detection network of claim 6, wherein each motion sensor comprises:
an imaging device for capturing representations of a respective region;
an analyzing system coupled to the imaging device for processing the representations in order to detect relative motion; and
a wireless transmitter coupled to the analyzing system and the wireless connection.

8. The motion detection network of claim 7, wherein each motion sensor further comprises a memory coupled to the imaging device.

9. The motion detection network of claim 7, wherein each motion sensor further comprises a light source for emitting light towards the respective region.

10. The motion detection network of claim 7, wherein the wireless transmitter comprises a bulk acoustic wave resonator.

11. The motion detection network of claim 7, wherein the representations comprise one of images and patterns.

12. A method for detecting relative motion in one or more regions using at least one motion sensor coupled to a central processing device over a wireless connection, the method comprising:
capturing representations of the one or more regions;
generating resulting data by processing the representations in order to detect relative motion; and
transmitting the resulting data to the central processing device.

13. The method of claim 12, further comprising detecting relative motion in the one or more regions using the resulting data.

14. The method of claim 12, further comprising programming the central processing device with one or more detection parameters.

15. The method of claim 12, wherein the representations comprise one of images and patterns.

16. The method of claim 15, further comprising programming the central processing device to perform a motion detection technique.

17. The method of claim 16, wherein the motion detection technique comprises one of image correlation, speckle translation, light and shadow pattern correlation, and laser interferometry.

18. The method of claim 13, further comprising taking an action based on the presence or absence of any relative motion in the one or more regions.

19. The method of claim 12, wherein capturing representations of the one or more regions comprises capturing representations of the one or more regions using reflected light.

20. The method of claim 12, wherein capturing representations of the one or more regions comprises capturing representations of the one or more regions using ambient light.
